(19) United States
(12) Patent Application Publication
(10) Pub. No.: US 2012/0271653 A1
(43) Pub. Date: Oct. 25, 2012

(54) SYSTEM AND METHOD FOR MEDICAL MESSAGING

(75) Inventors: Sarah Mitchell, Hightstown, NJ (US); Richard Vaughan, Wanaque, NJ (US); William Bartzak, Mendham, NJ (US); George Eleftheriades, Glen Rock, NJ (US)

(73) Assignee: MD ON-LINE, INC., Parsippany, NJ (US)

(21) Appl. No.: 13/089,736

(22) Filed: Apr. 19, 2011

(51) Int. Cl. G06Q 50/00

(52) U.S. Cl. 705/3

(57) ABSTRACT

A computer system generates medical messages based on an analysis of medical information associated with healthcare providers. The analyzed medical information may be derived from medical records and/or insurance claims, such as those that may be managed by a clearing house entity that manages the processing of medical insurance claims. Healthcare providers having certain patients that meet various analysis criteria may be identified for purposes of generating the messages that can serve to inform the health care providers about potential medical treatments and procedures, such as new drugs, that be significant for the health care provider and may also be significant to the patients of the health care provider who may be identified in the messages.

### FIELD OF THE TECHNOLOGY

The present technology relates to systems and methods for generating messages with health care information such as for healthcare providers. More particularly, the present technology relates to generating medical messages based on an analysis of medical information attributable to patients of healthcare providers.

### BACKGROUND

The management of medical care for patients by health care providers can involve a substantial amount of medical information. For example, physicians typically maintain records, such as doctor's notes, of their patients' medical conditions, medical history, treatment and visits. Moreover, the management of the payment and reimbursement for the costs of health care can typically require generation of medical codes and other necessary data concerning the treatment of patients to establish the right to reimbursement. Thus, it is common for health care providers to generate and submit medical insurance claims to obtain payment from insurers. An entity that processes medical insurance claim data, may receive tens of thousands of electronic insurance claims each day related to patient care. Furthermore, such an entity may receive this information from thousands of healthcare providers.

With such ever increasing administrative responsibilities for health care providers in the management of the practice medicine, it is increasingly difficult for health care providers to keep informed about advancements in medicine such as new procedures and treatments that may be particularly meaningful to the health care provider and for the health care provider's patients. For example, a physician with potentially hundreds of patients might not even easily recognize that information about a new treatment or procedure might be particularly relevant to the patients under his or her care. As such, there is a need to keep health care providers informed of the latest developments in medical research, technology, and patient care and to do so in a way that is meaningful for the health care providers.

Thus, it would be beneficial to provide medical educational information to healthcare providers in response to analyzing a large collection of data, such as data that may be readily available for analysis, to help providers keep up with new technologies and developments related to their specialty as well as to their patients so they may be positioned to provide the best care for their patients. Moreover, an ability for providers to stay informed in the context of existing information systems and/or through interactive feedback concerning their patients may help to create a greater understanding and validation of both physician and patient needs.

### BRIEF SUMMARY OF THE TECHNOLOGY

Disclosed embodiments relate generally to generating medical messages for healthcare providers. These messages may be generated by analyzing health information associated with healthcare providers, such as, for example, physician records and/or insurance claims data. The messages may be delivered to health care providers by various means, such as a secure web portal or email.

For example, in some embodiments, the technology may be implemented as a computer based method for educational messaging for health care providers. Such a method may include receiving, in a memory, medical information. The medical information may include health data attributable to a plurality of patients of one or more healthcare providers and may further include an association with a plurality of healthcare providers. The method may further involve analyzing, with a processor, the health data of the medical information based on one or more medical analysis criteria. The method may further involve identifying one or more healthcare providers of the plurality of healthcare providers based on the analyzing. The method may also involve generating a message to the one or more identified health care providers with message content including medical content associated with the medical analysis criteria.

In some embodiments, the medical analysis criteria may include a medical diagnosis. In some embodiments the medical content may include drug information for treatment of the medical diagnosis. Still further, the medical content may include treatment information for the medical diagnosis. In some cases, the medical analysis criteria may include one or more patient symptoms and the medical content may include treatment information for the medical diagnosis. In some embodiments, the medical information may include patient identification information. Optionally, the content may also include an identification of one or more patients of the plurality of patients where the one or more patients are associated with the medical analysis criteria. Still further, the medical analysis criteria may include a requirement that the identified health care provider have a plurality of patients associated with the medical diagnosis such that the plurality of patients exceeds a specified number of patients. In some embodiments of the method, the medical information may comprise medical treatment claims data and/or patient medical records.

In still further embodiments, the method may also include transmitting the medical message to the one or more healthcare providers via secured email. Optionally, the method may involve transmitting the medical message to the one or more healthcare providers in a secure web portal.

In some embodiments, the content may include a medical survey and/or an identification of a clinical trial. Optionally, the content may concern continuing medical education. Still further, the content may include medical insurance information. In some cases, the message may be associated with an electronic prescription.

Further embodiments of the present technology may be implemented as a system for educational messaging for health care providers. The system may include a memory operative to store medical information that includes health data attributable to a plurality of patients of one or more healthcare providers. The information may further include an association with a plurality of healthcare providers. The system may also include a processor in communication with the memory. The processor may be configured to analyze the health data of the medical information based on one or more medical analysis criteria and identify one or more healthcare providers of the plurality of healthcare providers based on the analyzing. The processor may also be configured to generate a message to the one or more identified health care providers such that the message includes content having medical content associated with the medical analysis criteria.

In some such cases, the medical analysis criteria may include a medical diagnosis. Similarly, the medical content may include drug information for treatment of the medical diagnosis. Still further, the medical content may include treatment information for the medical diagnosis.

Is some cases, the medical analysis criteria may include one or more patient symptoms and the medical content may include treatment information for the medical diagnosis. Optionally, the medical information may include patient identification information. In some embodiments, the content may also include an identification of one or more patients of the plurality of patients where the one or more patients are associated with the medical analysis criteria.

In some embodiments of the system, the medical information may include medical treatment claims data. In some cases, the processor may also be configured to transmit the medical message to the one or more healthcare providers via secured email. The processor may also be configured to transmit the medical message to the one or more healthcare providers in a secure web portal. In some cases, the health information may include patient medical records. Optionally, the content of the message may include medical insurance information. Additional features of the present technology will be apparent from a review of the following detailed discussion, drawings and claims.

### BRIEF DESCRIPTION OF THE DRAWINGS

The present technology is illustrated by way of example, and not by way of limitation, in the figures of the accompanying drawings, in which like reference numerals refer to similar elements including:

FIG. 1 is a diagram of a physician educational messaging system according to one embodiment of the present technology;

FIG. 2 is a functional diagram of a medical messaging server in accordance with some embodiments of the present technology;

FIG. 3 is a further diagram illustrating the system of FIG. 2.

FIG. 4 is flow diagram with a methodology for an example embodiment of a medical messaging system of the present technology; and

FIG. 5 is an example user interface including a message with medical content generated for a health care provider in accordance with the analysis methodologies of the present technology.

### DETAILED DESCRIPTION

Disclosed embodiments of the present technology relate generally to generating medical messages, such as electronic messages with medical educational information, for healthcare providers. Such messages may be generated based on an analysis of patients' medical information received from healthcare providers, such as data representing medical insurance claims and/or data representing physician medical records concerning patient care.

In this regard, a clearing house entity that processes medical insurance claims may receive tens of thousands of insurance claims each day related to patient care from one or more health care providers. Such records are typically electronically processed by the systems of the clearing house entity for purposes of conforming the claims data to the requirements of payor entities such as one or more medical insurance entities.

Thus, the clearing house entity may facilitate transactions between healthcare providers, such as doctors and hospitals, on the one hand, and payers, such as health insurers on the other hand. To handle transactions between providers and payers, the clearing house entity can receive medical information directly from healthcare providers in various ways, such as, for example, via a secure web portal, file transfer or secure email. This information may be used for such things as payment processing, eligibility verification, referrals, and claim submission and status. As such, the clearing house entity may maintain and access a large collection of medical information, including, for example, insurance claims data having patient diagnoses, provider information and insurer information that may be attributable to many patients and many health care providers. In some cases, the clearing house entity may even serve as a health care information technology company such as by maintaining electronic medical records (e.g., doctors' treatment and visitation notes) of one or more healthcare providers.

In addition to, or as an alternative to, performing an analysis of the data to substantiate or conform the claims information to the requirements of payors for submission to the payors, the systems of the clearing house entity or health care information technology company may also be configured to perform an analysis of the received information for purposes of generating medical educational information for the health care providers. Such an analysis may be based on medical criteria related to health data, such as, for example, patient symptoms, patient diagnoses, or medical procedures performed on patients by the health care providers. The systems of the clearing house entity or health care information technology company may then identify one or more healthcare providers that could benefit from certain medical educational information as a result of the analysis. Thus, the systems may then generate a message for delivery to the identified providers with medical information that may be significant to the health care provider and, more significantly, may be particularly significant for one or more patients of the health care provider.

For example, the computer systems of clearing house entity or health care information technology company with a collection of medical information may be programmed to perform an analysis on data related to patients of the health care provider who have a certain health condition, such as asthma, using certain analysis criteria. The data analysis may include identifying or detecting patients with symptoms or diagnoses associated with asthma. Based on this analysis, the entity may identify one or more healthcare providers associated or responsible for those patients with asthma. The entity may then generate a medical educational message to the identified health care providers with message content that describes or mentions, for example, a medical treatment for the analyzed health condition (e.g., asthma).

As discussed in more detail herein, such messages may be directed to the identified health care providers of the patients and may identify new medications for the health condition or new treatments, new medical equipment, new medical devices, etc. The message content may even optionally specifically identify to the health care provider the particular patients of the physicians who might benefit from the treatments or medical suggestions of the message. In some cases, the analysis criteria may be selected to particularly direct messages that are especially suited for some health care providers. For example, analysis criteria may be selected to identify health care providers having a certain number of patients that exceed some minimum target number. For example, the analysis criteria may be selected to identify health care providers who have at least a certain minimum number of patients with particular symptoms and/or diagnosis such that a message may be generated with content to identify a clinical trial that my be suitable for the particular patients of the health care provider. It will be recognized that other analysis criteria and medical messages may also be implemented in such a system, such as the further example discussed in more detail herein.

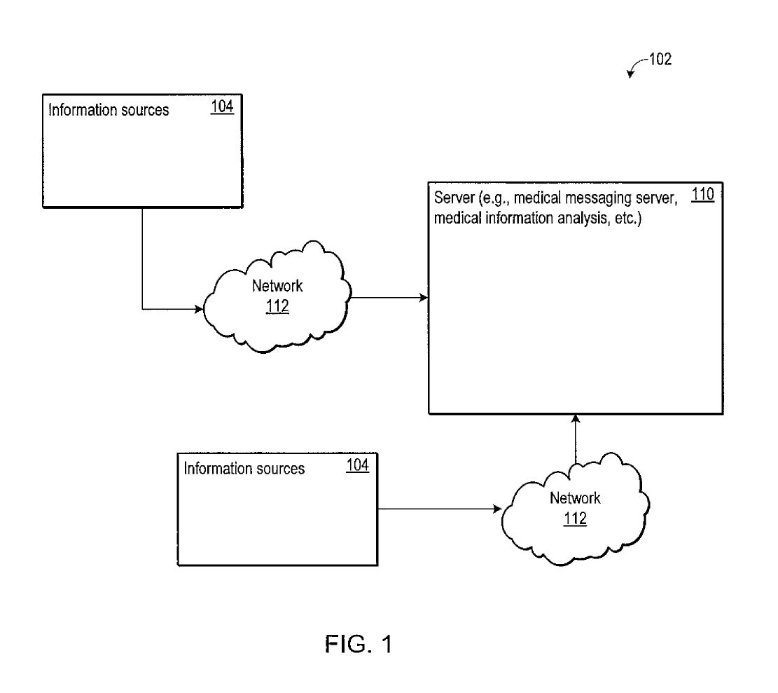

To these ends, FIG. 1 illustrates suitable components for implementing such a messaging system with an apparatus 102 for generating medical messages for healthcare providers. The apparatus 102 may include a computer, such as a server 110 or servers in communication with one or more information sources 104. The information sources 104 may include any number and type of information sources. Such information sources may include one or more databases or database servers. As discussed in more detail herein, such database servers may contain, for example, medical data submitted by client devices, such as in the processing of medical insurance claims and/or in the context of a distributed electronic medical records storage system with doctors visitation notes (e.g., patient records). Thus, the information sources 104 may communicate with the server 110 through one or more networks 112. The server 110 may, for example, operate on a privately accessible network, such as a local area network of a business, in communication with a publicly accessible network, such as the Internet. Although the information sources are shown as being distinct from the server 110, it will be recognized that the information source(s) may also be part of the server 110.

As previously mentioned, the information source 104 may be a data store with any type of health information related to healthcare providers, such as, for example, physician notes, insurance claims, patient data including for example, patient identity information, insurer identify information, provider specialty, patient diagnoses, procedures performed, remittance advice, medicines (e.g., drug prescriptions or over-the-counter drugs), laboratory results, testing results and a combination of any of these or any other pertinent healthcare information. Additionally, the information may be a collection or cluster of information related to the healthcare provider. Thus, the medical information may include associations between patients and their health care providers, associations between patients and their health conditions and/or associations between health care providers and the health conditions of their patients. As additional medical information is gathered, the data may be updated with additional information, such as by updating the information sources, which may optionally be performed by the server 110.

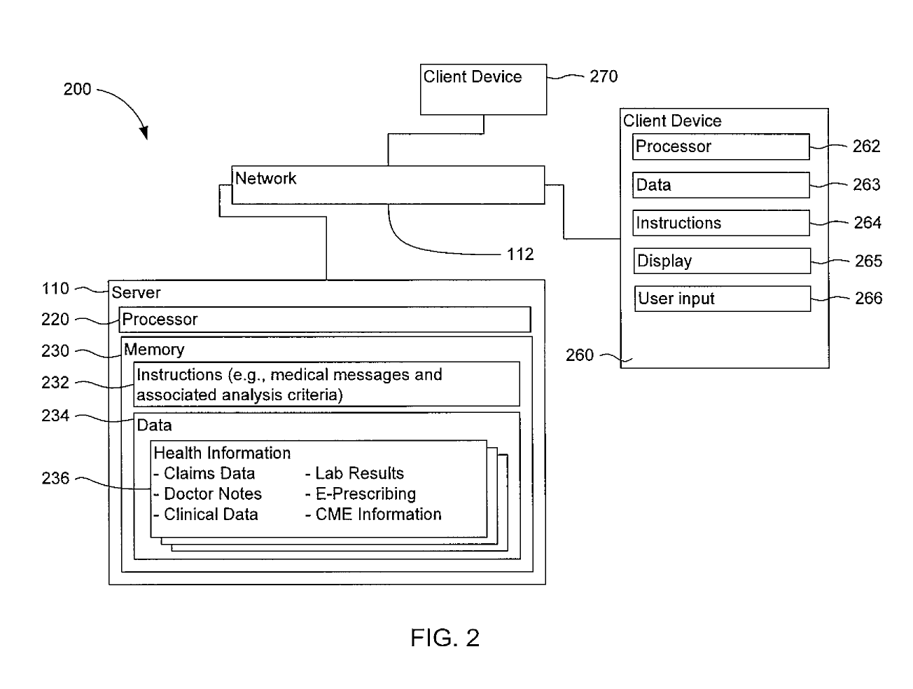

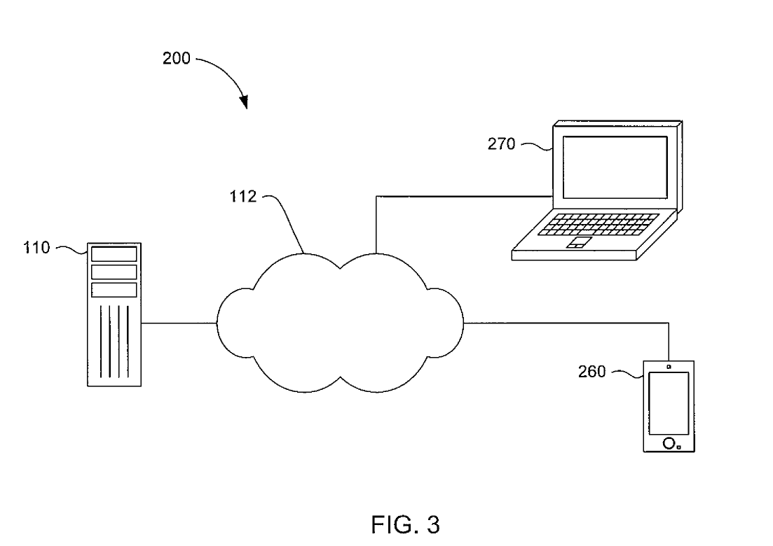

FIGS. 2 and 3, illustrate the medical messaging system 200 in accordance with some embodiments of the present technology. As previously mentioned, the medical messaging system may be a computer or server configured with programming instructions comprising medical analysis criteria to perform an analysis of medical information of the data of the information sources for generating messages for medical providers. Thus, such a server 110 may include one or more processors 220, memory 230 and other components typically present in general purpose computers. However, with the programming of the processor in accordance with the methods and algorithms described herein, the server can serve as a special purpose computer.

Thus, the memory 230 of the computer will typically include stored information accessible to processor(s) 220, including program instructions 232, such as instruction which comprise or access medical analysis criteria and associated medical messages, and data 234, such as medical information retrieved from the information sources, that may be executed or otherwise accessed by the processor(s) 220. The memory 230 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 232 may be any set of instructions to be executed directly (such as machine code) or indirectly (such as scripts or database queries) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in the context of the embodiments discussed herein.

The data 234, such as data that represents medical information, may be retrieved, accessed and analyzed by processor 220 in accordance with the instructions 232. For instance, although the architecture is not limited by any particular data structure, the data may be stored in computer registers, in a relational database as a table having a plurality of different fields and records, XML documents or flat files. The data may also be formatted in any computer-readable format. The data may comprise any information sufficient to identify the relevant information, such as numbers, descriptive text, proprietary codes, references to data stored in other areas of the same memory or different memories (including other network locations) or information that is used by a function to access and analyze the data relevant to a given analysis criteria.

Although FIG. 2 functionally illustrates the processor and memory as being within the same block, it should be understood that the processor and memory may actually comprise multiple processors and memories that may or may not be stored within the same physical housing. For example, the memory 230 may be a hard drive or other storage media located in a server farm of a data center. Accordingly, references to a processor, a computer or a memory will be understood to include references to a collection of processors, computers or memories that may or may not operate in parallel.

Moreover, the server 110 may be at one node of a network 112 and may be capable of directly and indirectly receiving data from other nodes of the network. For example, server 110 may comprise a web server that is capable of receiving data from client devices 260 and 270 via network 112 such that server 110 uses network 112 to transmit and display information to a user on display 265 of client device 270. Thus, the server may be configured with a user interface, such as a web page for health care providers for purposes of exchanging or accessing claims information and medical records with the server. Such an interface may also be configured for receiving medical information messages generated in accordance with analysis criteria programs of the server. Similarly, the server may be configured with a user interface, such as a web page, to permit a user to initiate an analysis such as for providing analysis criteria to the server so that the server may execute the medical analysis program as described in more detail herein. It will be understood that server 110 may also comprise a plurality of computers that exchange information with different nodes of a network for the purpose of receiving, processing and transmitting data to such client devices. In such as case, the client devices may typically still be at different nodes of the network than any of the computers comprising server 110.

Network 112, and intervening nodes between server 110 and clients or other devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 2-3, it should be appreciated that a typical messaging system contemplated by the current disclosure may include a large number of connected computers, which may be used by a large number of health care providers.

Thus, each client device may be configured similarly to the server 110, with a processor, memory and instructions as described above. Each client device 260 or 270 may be a personal computer intended for use by a person, such as a health care provider, and have all of the components normally used in connection with a personal computer such as a central processing unit (CPU) 262, memory (e.g., RAM and internal hard drives) storing data 263 and instructions 264, an electronic display 265 (e.g., a monitor having a screen, a touch-screen, a printer or any other electrical device that is operable to display information), and user input 266 (e.g., a mouse, keyboard, touch-screen or microphone).

Although the client devices 260 and 270 may each comprise a full-sized personal computer, they may alternatively comprise mobile devices capable of wirelessly exchanging data with a server over a network such as the Internet. By way of example only, client device 260 may be a wireless-enabled PDA or a cellular phone capable of obtaining information via the Internet. The user may input information, e.g., using a small keyboard, a keypad or a touch screen.

As previously mentioned, the data 234 of server 110, which may be retrieved by requests to the information sources, will typically include health information data 236 to be analyzed in accordance with the programming of the medical analysis criteria. Thus, in typical embodiments of the present technology, such analyzed health or medical information data 236 may include insurance claim data that may identify an insurance claim from a healthcare provider. Additionally, the health information data 236 may include doctor's notes regarding one or more patients. Furthermore, the health information data 236 may also include clinical data, lab results, e-prescriptions, CPT codes, continuing medical education (CME), or any other information relevant to a healthcare provider or patient health.

In addition to the operations previously described, various example operations of the system will now be described. It should also be understood that the data analysis and messaging operations of the following examples do not have to be performed in the precise order described below. Rather, various steps can be processed in a different order, simultaneously or in parallel. Steps of the processes may also be removed or added.

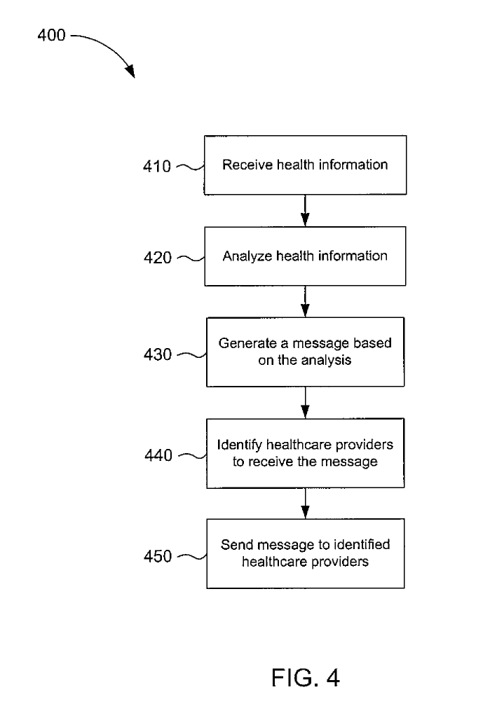

FIG. 4 is an example methodology 400 of a processor(s) for generating medical messages for healthcare providers in accordance with the teachings of the present technology. Healthcare providers may include, for example, individual doctors, clinicians, medical partnerships, hospitals, hospices, or any other entity that may provide health care services for patients. At 410, a computer or server 110 accesses health information, such as from information sources 104. As previously described, this health information may include information related to healthcare providers, such as, for example, doctor's notes, insurance claims data, patient data, health care provider specialty, diagnosis data or codes, procedures performed, remittance advice, prescriptions, laboratory results, a combination of any of these or any other pertinent healthcare information.

At 420, the server 110 may analyze the medical information accessed. The data may be analyzed based on various programmed analysis criteria. For example, in some embodiments, the analysis may be performed using a rules-based system, such as an expert system. For example, the server 110 may be configured to include rules that analyze insurance claims and/or doctor notes for particular symptoms associated with a disease. Such a rules based analysis may, for example, evaluate data for concurrence between particular search term criteria and terms or codes of the analyzed medical data. Such a concurrence may be implemented to include or exclude certain health care providers and/or their patients from the results of the analysis. In some embodiments, the analysis may be performed in response to one or more queries. For example, the server 110 may process a query that involves analyzing insurance claims and/or doctor notes for diagnoses and/or symptoms that could be treated with a particular drug so as to permit an identification of particular patients and/or their health care providers based on the aforementioned associations between them.

In one embodiment, the server 110 may analyze patient treatment dates associated with a healthcare provider to determine whether the provider should offer a certain type of patient care. For example, the analysis of the server 110 may involve a determination of whether a patient is due for a checkup or medical appointment. In another example, the server 110 may analyze patient health data to determine whether the healthcare provider associated with the patient should consider performing a particular test or procedure for one or more patients. The server 110 may analyze doctor notes or insurance claim data to determine which test or procedure a healthcare provider should consider performing or has already performed.

In yet another embodiment, the server 110 may analyze health information for patients to determine whether the patients' health care provider is suitable to be contacted for a particular medical survey. For example, the analysis criteria may include the provider's specialty, geographic location, previous survey answers, patient base, or any combination of these or other information associated with the healthcare provider that may be relevant in determining whether a provider should participate in the survey.

In a further embodiment, the server 110 may analyze health information, such as insurance claim data, doctor notes, or provider specialty, associated with a healthcare provider to determine whether any patients may satisfy requirements for participating in a clinical trial. For example, the server 110 may evaluate diagnoses, patient symptoms, procedures performed, or any combination of these or other information relevant for recommending clinical trials.

In yet another embodiment, the server 110 may analyze health information to determine whether a healthcare provider may qualify for a CME opportunity. The server 110 may consider information such as, for example, provider specialty, types of patients, geographic location, or any combination of these or other relevant information.

In yet another embodiment, the server 110 may analyze health information to determine whether a healthcare provider should receive a message related to a healthcare payer such as a health insurer, HMO, PPO, or other healthcare coverage entity. For example, the healthcare provider may receive a message regarding patients associated with the provider who are covered by a payer and are eligible for a particular benefit from the payer.

In another embodiment, the server 110 may analyze health information to determine whether to send a healthcare provider material related to a prescription or over-the-counter medicine such as a brand name or generic drug. For instance, the server 110 may analyze prescription information to determine whether a healthcare provider should receive a coupon for a particular drug to pass on to patients.

In yet another embodiment, the server 110 may analyze health information to determine whether a healthcare provider should receive patient education materials. For example, information such as clinical data may be analyzed to determine whether a healthcare provider should receive an educational video that can be used by the physician to educate patients or can be provided to the patients by the physician.

In yet another embodiment, the server 110 may analyze health information to determine whether a healthcare provider should receive information about another healthcare provider to promote provider-to-provider communication. For example, health information may be analyzed to determine whether one or more healthcare providers have certain patients with certain symptoms. A message then may be generated for the identified healthcare provider(s) with contact information of another healthcare provider who may have similar patients and may be able to provide assistance to the identified healthcare provider(s).

In yet another embodiment, the server 110 may analyze health information to determine whether a healthcare provider should receive information about a particular type of insurance information, such as medical malpractice insurance. For example, health information may be analyzed to determine whether one or more healthcare providers have certain patients with certain symptoms. A message then may be generated for the identified healthcare provider(s) with information concerning malpractice insurance for such an area of treatment.

At 430, the server 110 may then generate messages based on the analysis at 420. Such message may include the content, such as the medical content previously described. For example, if the server 110 determines that a healthcare provider has patients who are eligible for a clinical trial in accordance with the analysis criteria, the server 110 may generate one or more messages that reflect that determination. These messages may be generated based on symptoms or diagnoses associated with patients of a particular healthcare provider. Moreover, the messages may include portions of the analyzed data, such as which diagnoses make a patient eligible for the trial, as well as a description of the proposed clinical trial.

At 440, the server 110 may also identify particular healthcare providers that may find the messages generated at 430 useful or relevant. For example, as previously mentioned one or more healthcare providers may be identified for receiving a message for a clinical trial in accordance with their association to, for example, one or more patients having the diagnosis data of the analysis criteria. Thus, the providers may be identified based on, for example, their association with one or more of their patients who have been determined to be eligible to participate in the trial according to the aforementioned analysis. In another example, one or more providers may be identified to participate in a survey based on such factors as the providers' geographic location, specialty, and/or patient base. In yet another example, one or more healthcare providers may be identified to receive a patient care alert related to, for example, a treatment for a particular diagnosis.

At 450, server 110 may send the messages generated at 430 to the healthcare providers identified at 440. For example, the server 110 may send the messages via a secure web portal that allow healthcare providers to have access via secure login, such as within a web browser. In another example, the server 110 may send the messages via e-mail, such as by an encrypted or secure email transmission so as to preserve patient privacy such as in the event that the message identifies a particular patient. For example, in some embodiments the email or other message transmissions may be encrypted and/or sent within a secure network. In still further embodiments, secure messages may be rendered in a software application, other than a web browser, that is particularly designed for secure communications with the server 110 of the system.

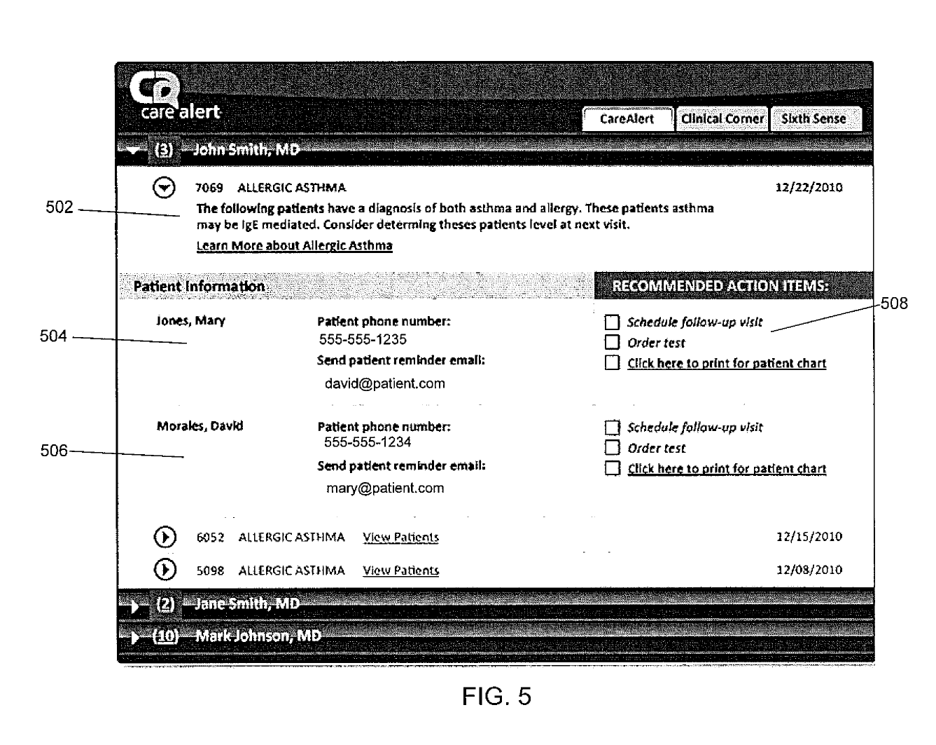

For example, FIG. 5 shows a user interface embodiment of a secure web portal that may be implemented by the server to provide identified health providers access to the generated medical messages. In this example, messages are displayed for an identified physician named John Smith based on analysis criteria that defined a particular diagnosis for his patients. These messages may have been generated based on an analysis of the health information of the doctor's notes, medical records and/or insurance claims data for Dr. John Smith's patients. As a result of the analysis, the server 110 may have generated one or more messages, including, in this example, one or more messages related to patients associated with Dr. John Smith who are diagnosed with allergic asthma.

In the example, the message for Dr. John Smith displayed in FIG. 5 includes medical content that will be particularly significant to Dr. Smith and his patients. The message contains medical content 502 identifying that Dr. John Smith has patients diagnosed with allergic asthma. In further content of the message, each patient associated with the medical content of the message may be identified such as by giving patient information 504 regarding Mary Jones, and the patient information 506 regarding David Morales. In yet another embodiment, the communication 502 and patient information 504 and 506 may collectively constitute a single message generated by server 110. The message content at 510 may inform the physician of the potential for further treatment and/or procedures that may be associated with the particular diagnosis of the analysis criteria. For example, although not shown at 510, a drug treatment (e.g., a prescription or over-the-counter medication), may be identified at 510 to educate or inform the physician about the drug or treatment and its relevance to the physician's particular patients that may be identified.

In another embodiment of the present technology, the server 110 may analyze patient drug information (e.g., prescriptions and over-the-counter drugs), for example from claims data, to detect incompatibilities between multiple drugs of a given patient using certain analysis criteria involving the prescription data. Upon detecting an incompatibility, a message may be generated for the prescribing physician to identify the patient to the physician. The message may further include medical content to identify the incompatibility between the prescriptions. Moreover, the message may further identify an alternative prescription that may be utilized to treat the symptoms or diagnosis of the patient to remove the incompatibility.

In another embodiment of the present technology, the server 110 may analyze patient health information such as prior diagnosis and/or procedure information. Based on the analysis, a message may be generated to an identified healthcare provider to alert the provider when identified patients are due for follow-up treatments, physicals, and/or other annual wellness or recurring treatments (e.g., mammograms, eye exams, vaccinations, allergy shots, flu shots, etc.).

In another embodiment, of the present technology, the server 110 may analyze health information of similar patients of different providers to inform providers what types of treatments or procedures are available for similar patients. For example, by analyzing diagnosis and/or symptoms and the related treatment or procedure data (e.g. CPT codes) of one or more providers' patients, a message may be generated for a different provider that has patients with similar or same diagnosis and/or symptoms to identify to the different provider the types of procedures or treatments other providers are using to treat such patients. Thus, the message may inform the different provider of the potential treatments for his/her patients who have the particular symptoms and/or diagnosis. The message to the provider may also identify his/her patients who might be the candidates for the potential treatments or procedures based on the patients having the particular diagnosis and/or symptoms. Such a message to the provider may also be generated so as to exclude his/her patients who have already been treated with the potential treatments or procedures.

Although the invention herein has been described with reference to particular embodiments, it is to be understood that these embodiments are merely illustrative of the principles and applications of the present technology. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects. It is therefore to be understood that numerous modifications may be made to the illustrative embodiments and that other arrangements may be devised without departing from the spirit and scope of the present invention as defined by the appended claims. For example, although the aforementioned example systems may be implemented in a distributed system by one or more servers and one or more clients, in some embodiments the system may be implemented in a stand alone computer where the software and storage components of the different computers may be implemented by a single computer, such as where the storage, analysis and resulting message generation is performed in one machine.

1. A computer-implemented method for educational messaging for health care providers, the method comprising:
receiving, in a memory, medical information, the medical information comprising health data attributable to a plurality of patients of one or more healthcare providers, the information further including an association with a plurality of healthcare providers;
analyzing, with a processor, the health data of the medical information based on one or more medical analysis criteria;
identifying one or more healthcare providers of the plurality of healthcare providers based on the analyzing;
generating a message to the one or more identified health care providers, the message comprising content, the content including medical content associated with the medical analysis criteria.

2. The method of claim 1 wherein the medical analysis criteria comprises a medical diagnosis.

3. The method of claim 2 wherein the medical content comprises drug information for treatment of the medical diagnosis.

4. The method of claim 2 wherein the medical content comprises treatment information for the medical diagnosis.

5. The method of claim 1 wherein the medical analysis criteria comprises one or more patient symptoms and the medical content comprises treatment information for the medical diagnosis.

6. The method of claim 1 wherein the medical information includes patient identification information.

7. The method of claim 6 wherein the content further comprises an identification of one or more patients of the plurality of patients, the one or more patients being associated with the medical analysis criteria.

8. The method of claim 7 wherein the medical analysis criteria comprises a requirement that the identified health care provider have a plurality of patients associated with the medical diagnosis, the plurality of patients exceeding a specified number of patients.

9. The method of claim 1 wherein the medical information comprises medical treatment claims data.

10. The method of claim 1, further comprising transmitting the medical message to the one or more healthcare providers via secured email.

11. The method of claim 1, further comprising transmitting the medical message to the one or more healthcare providers in a secure web portal.

12. The method of claim 1, wherein the health information includes patient medical records.

13. The method of claim 1, wherein the content comprises a medical survey.

14. The method of claim 1, wherein the content comprises an identification of a clinical trial.

15. The method of claim 1, wherein the content concerns continuing medical education.

16. The method of claim 1, wherein the content comprises medical insurance information.

17. The method of claim 1, wherein the message is associated with an electronic prescription.

18. A system for educational messaging for health care providers, the system comprising:
a memory operative to store medical information, the medical information comprising health data attributable to a plurality of patients of one or more healthcare providers, the information further including an association with a plurality of healthcare providers;
a processor in communication with the memory, the processor configured to:
analyze the health data of the medical information based on one or more medical analysis criteria;
identify one or more healthcare providers of the plurality of healthcare providers based on the analyzing; and
generate a message to the one or more identified health care providers, the message comprising content, the content including medical content associated with the medical analysis criteria.

19. The system of claim 18 wherein the medical analysis criteria comprises a medical diagnosis.

20. The system of claim 19 wherein the medical content comprises drug information for treatment of the medical diagnosis.

21. The system of claim 19 wherein the medical content comprises treatment information for the medical diagnosis.

22. The system of claim 18 wherein the medical analysis criteria comprises one or more patient symptoms and the medical content comprises treatment information for the medical diagnosis.

23. The system of claim 18 wherein the medical information includes patient identification information.

24. The system of claim 23 and wherein the content further comprises an identification of one or more patients of the plurality of patients, the one or more patients being associated with the medical analysis criteria.

25. The system of claim 18 wherein the medical information comprises medical treatment claims data.

26. The system of claim 18, wherein the processor is further configured to transmit the medical message to the one or more healthcare providers via secured email.

27. The system of claim 18, wherein the processor is further configured to transmit the medical message to the one or more healthcare providers in a secure web portal.

28. The system of claim 18 wherein the health information includes patient medical records.

29. The system of claim 18 the content comprises medical insurance information.
